(19) United States
(12) Patent Application Publication
(10) Pub. No.: US 2026/0189646 A1
(43) Pub. Date: Jul. 2, 2026

(54) OMNIDIRECTIONALLY ADJUSTABLE MOBILE PHONE HOLDER

(71) Applicant: Shenzhen Yuanrunxin Electronics Co., Ltd., Shenzhen (CN)

(72) Inventors: Tao YANG, Shenzhen (CN); Cheng CHEN, Shenzhen (CN); Yuanlian HUANG, Shenzhen (CN); Guowu HUANG, Shenzhen (CN); Fang CHEN, Shenzhen (CN)

(73) Assignee: Shenzhen Yuanrunxin Electronics Co., Ltd., Shenzhen (CN)

(21) Appl. No.: 19/014,584

(22) Filed: Jan. 9, 2025

(30) Foreign Application Priority Data
Dec. 27, 2024 (CN) 202423236567.7

(51) Int. Cl. H04M 1/04

(52) U.S. Cl. CPC H04M 1/04

(57) ABSTRACT

The present invention discloses an omnidirectionally adjustable mobile phone holder comprising: a mobile phone clamp having a supporting surface and a connecting surface; a support seat used to contact a position for placement; and a connecting piece connected with the connecting surface of the mobile phone clamp and the support seat. By means of arranging the connecting piece to enable the mobile phone clamp to be multi-directionally adjusted with respect to the support seat, it is convenient for users to adjust the position of the mobile phone towards the position suitable for themselves according to different usage requirements, improving the convenience of use; the magnetic accepter and the ball head are connected with each other by magnetic attraction, so that it is free to turn and adjust the mobile phone clamp for an angle, effectively improving the convenience of adjustment, and achieving omnidirectional adjustment in a wide range.

### FIELD OF THE INVENTION

The present invention relates to a mobile phone holder, specifically an omnidirectionally adjustable mobile phone holder.

### BACKGROUND OF THE INVENTION

A mobile phone holder is a piece of apparatus used to hold and support a mobile phone, by which the mobile phone can be placed at a fixed position, allowing users to freely use the mobile phone without holding it.

The mobile phone holder can aid users in fixing the mobile phone at a suitable angle and height for viewing movies, videos and TV shows, and users can place the mobile phone holder on a desk or a bedside cupboard to make the phone screen at the best angle, avoiding visual fatigue during holding and providing a better viewing experience.

The mobile phone holder is not only used for viewing and entertainment, but also plays a certain role during driving, which can effectively eliminate the potential safety hazards caused by action that a user hands a mobile phone during driving.

An existing mobile phone holder generally comprises a mobile phone clamp, a connecting arm and a base, the mobile phone clamp is hinged with the connecting arm, the connecting arm is rotatably connected with the base simultaneously; thus, it is only possible to turn the mobile phone clamp upwards and downwards at the time of adjusting an angle for placing the mobile phone clamp, and simultaneously turn the connecting arm again; therefore, such adjustment mode is more complicated and inconvenient for operation.

### SUMMARY OF THE INVENTION

An objective of the present invention is to provide an omnidirectionally adjustable mobile phone holder so as to solve the problem proposed in the above-mentioned background art.

In order to achieve the above objective, the invention provides the following technical solution.

An omnidirectionally adjustable mobile phone holder includes:
a mobile phone clamp having a supporting surface and a connecting surface, wherein a support piece used to restrict the mobile phone in position is arranged on the supporting surface;
a support seat used to contact a position for placement; and
a connecting piece connected with the connecting surface of the mobile phone clamp and the support seat, so as to enable multi-directional adjustment to the mobile phone clamp with respect to the support seat.

In the aforementioned omnidirectionally adjustable mobile phone holder, the support piece includes a bearing piece formed at one end of the mobile phone clamp, and a rubber cushion is arranged at a position where the bearing piece contacts the mobile phone.

In the aforementioned omnidirectionally adjustable mobile phone holder, an embedment groove is further set on the mobile phone clamp and a camera protruding from the mobile phone can be disposed inside the embedment groove.

In the aforementioned omnidirectionally adjustable mobile phone holder, the connecting piece includes a ball head connected with the support seat and a magnetic accepter fixed to the connecting surface of the mobile phone clamp, wherein the magnetic accepter attracts the ball head to connect the mobile phone clamp with the support seat; or
the connecting piece include a magnetic accepter connected the support seat and a ball head fixed to the connecting surface of the mobile phone clamp, wherein the magnetic accepter attracts the ball head to connect the mobile phone clamp with the support seat.

In the aforementioned omnidirectionally adjustable mobile phone holder, a spherical groove with the same diameter as the ball head is formed on one side of the magnetic accepter facing the ball head.

In the aforementioned omnidirectionally adjustable mobile phone holder, the support seat includes a base and a supporting arm, and the supporting arm includes a movable connecting frame fixed to the ball head or the magnetic accepter and a rotatable connecting frame hinged with the movable connecting frame; a turntable that is rotatably connected with the rotatable connecting frame is formed on the base.

In the aforementioned omnidirectionally adjustable mobile phone holder, the support seat includes a support fixed to the ball head or the magnetic accepter and a mount connected with the support.

In the aforementioned omnidirectionally adjustable mobile phone holder, the support is in a shape of column, such as “>” or “<”.

Compared with the prior art, the present invention has the following beneficial effects.

By means of arranging the connecting piece to enable the mobile phone clamp to be multi-directionally adjusted with respect to the support seat, it is convenient for users to adjust the position of the mobile phone towards the position suitable for themselves according to different usage requirements, effectively avoiding the drawbacks that the existing mobile phone holder can only be adjusted upwards and downwards and adjusted rotatably, and improving the convenience of use; the magnetic accepter and the ball head are connected with each other by magnetic attraction, so that it is free to turn and adjust the mobile phone clamp for an angle, effectively improving the convenience of adjustment, and achieving omnidirectional adjustment in a wide range, which can better adapt to usage requirements of users.

### BRIEF DESCRIPTION OF THE DRAWINGS

FIG. 1 is a structural diagram of one embodiment of the omnidirectionally adjustable mobile phone holder.

FIG. 2 is a structural diagram of one embodiment of the omnidirectionally adjustable mobile phone holder form another perspective.

FIG. 3 is a diagram showing a state of the supporting arm separating from the mobile phone clamp in one embodiment of the omnidirectionally adjustable mobile phone holder.

FIG. 4 is a diagram showing a state of the supporting arm separating from the mobile phone clamp in one embodiment of the omnidirectionally adjustable mobile phone holder form another perspective.

FIG. 5 is a structural diagram of another embodiment of the omnidirectionally adjustable mobile phone holder.

FIG. 6 is a structural diagram of another embodiment of the omnidirectionally adjustable mobile phone holder form another perspective.

With reference to the marks in the description.

1-mobile phone clamp; 101-embedment groove; 102-bearing piece; 103-rubber cushion; 2-base; 201-turntable; 3-supporting arm; 301-movable connecting frame; 302-rotatable connecting frame; 4-connecting piece; 401-ball head; 402-connecting plate; 403-magnetic accepter; 404-spherical groove; 5-support; 6-mount.

### DETAILED DESCRIPTION OF SOME EMBODIMENTS

We shall describe the various exemplary embodiments, features and aspects of the present invention in detail with reference to the figures as follows. The same marks in the figures indicate elements with the same or similar function. Although various aspects of embodiments are shown in the figures, it is not necessary to draw figures to scale unless otherwise specified.

The word “exemplary” used here means “to be used as an example and an embodiment, or illustrative”. Any embodiment illustrated herein as “exemplary” need not be construed as superior or better than the other embodiments.

In addition, in order to better illustrate the present invention, many details are provided in the specific embodiments as follows. A person skilled in the art will understand that the present invention can also be implemented without certain specific details. In some cases, the methods, means, and members familiar to a person skilled in the art are not described in detail, so as to highlight essence of the invention.

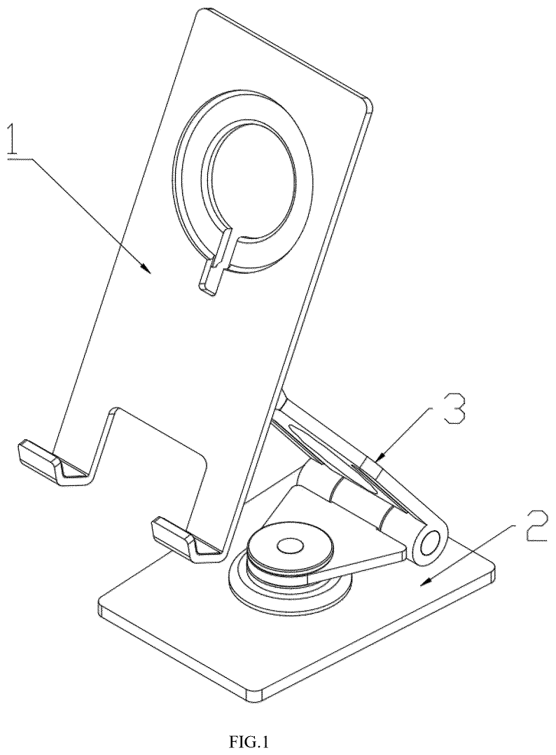

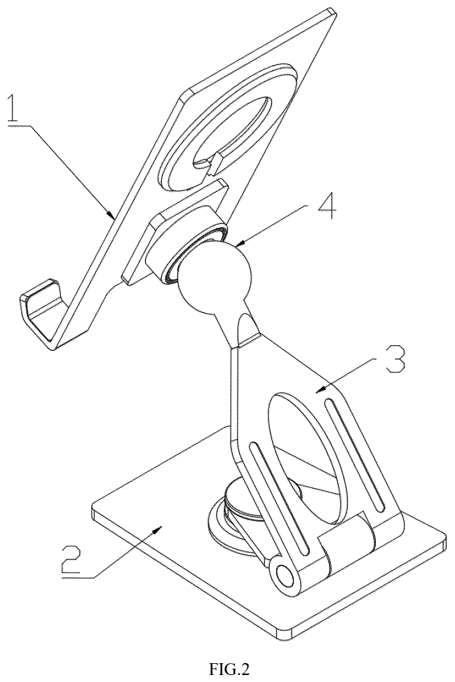

As shown in FIGS. 1-2, in one embodiment of the present invention, an omnidirectionally adjustable mobile phone holder includes:
a mobile phone clamp 1 having a supporting surface and a connecting surface, wherein a support piece used to restrict the mobile phone in position is arranged on the supporting surface;
a support seat used to contact a position for placement; et
a connecting piece 4 connected with the connecting surface of the mobile phone clamp 1 and the support seat, so as to enable multi-directional adjustment to the mobile phone clamp 1 with respect to the support seat.

In this embodiment, the mobile phone clamp 1 is connected with the support seat by means of the connecting piece 4 and used to support the mobile phone, and the support seat can be placed at a position for placement, which includes but is not limited to a table surface; of course, in an example, the support seat may also be provided as a clamping jaw structure, which is used to be clamped to a table board, a piece in a vehicle and likes, and to which one it is clamped can be selected according to actual needs, and this embodiment does not pose a particular limitation on that.

By means of arranging the connecting piece 4 to enable the mobile phone clamp 1 to be multi-directionally adjusted with respect to the support seat, it is convenient for users to adjust the position of the mobile phone towards the position suitable for themselves according to different usage requirements, effectively avoiding the drawbacks that the existing mobile phone holder can only be adjusted upwards and downwards and adjusted rotatably, and improving the convenience of use.

In an exemplary embodiment, the support piece includes a bearing piece 102 formed at one end of the mobile phone clamp 1, and a rubber cushion 103 is arranged at a position where the bearing piece 102 contacts the mobile phone. The bearing piece 102 is used to stay against the lower end of the mobile phone to support the mobile phone, and the bearing piece 102 is provides as a U-shaped structure; thus, the bearing piece 102 contacts the mobile phone, so as to restrict the bottom and the front and rear ends of the mobile phone in position, preventing the mobile phone from falling out of the mobile phone holder due to shaking or other reasons. Such structure effectively improves a practical effect for the mobile phone and plays an effective protective role for the mobile phone.

In another exemplary embodiment, the support piece has a magnet embedded on the mobile phone clamp 1, and in the process of use, the mobile phone can be configured with a mobile phone case with metal, and when the mobile phone needs to be placed on the mobile phone clamp 1, the magnet attracts the metal to realize the fixation of the mobile phone.

In a further embodiment, an embedment groove 101 is further set on the mobile phone clamp 1 and a camera protruding from the mobile phone can be disposed inside the embedment groove 101. With reference to existing mobile phone structures, it can be seen that in order to improve the clarity of pictures taken by the mobile phone, the camera of the mobile phone will typically protrude from the rear end face of the mobile phone; thus it is possible to reduce the contact friction between mobile phone camera and the mobile phone clamp 1 to a certain extent by means of arranging the embedment groove 101 and play an effective protective role for the mobile phone camera; in addition, after the mobile phone camera is placed in the embedment groove 101, the contact area between the rear end surface of the mobile phone and the mobile phone clamp 1 increases, enabling an improvement in the stability of the connection between the mobile phone and the mobile phone clamp 1; of course, after the mobile phone camera is placed in the embedment groove 101, it is possible to restrict the mobile phone in position to a certain extent, and keep a further increase in the stability of the connection between the mobile phone and the mobile phone clamp 1.

As shown in FIGS. 2,4 and 6, the connecting piece 4 includes a ball head 401 connected with the support seat and a magnetic accepter 403 fixed to the connecting surface of the mobile phone clamp 1, wherein the magnetic accepter 403 attracts the ball head 401 to connect the mobile phone clamp 1 with the support seat; in this way, the magnetic accepter 403 and the ball head 401 are connected with each other by magnetic attraction, so that it is free to turn and adjust the mobile phone clamp 1 for an angle, effectively improving the convenience of adjustment, and achieving omnidirectional adjustment in a wide range, which can better adapt to usage requirements of users.

Here, it should be noted that the magnetic accepter 403 and the mobile phone clamp 1 are connected with each other through a connecting plate 402; the magnetic accepter 403 has strong magnetic performance, the ball head 401 is metal that can attract magnet; when the magnetic accepter 403 and the ball head 401 have attracted each other, it is ensured that no free turn occurs to the mobile phone after placing it on mobile phone clamp 1.

During implementing this embodiment, it is possible to reverse the positions of the magnetic accepter 403 and the ball head 401 for connection; for example, the connecting piece 4 includes a magnetic accepter 403 connected with the support seat and a ball head 401 fixed to the connecting surface of the mobile phone clamp 1, and the magnetic accepter 403 attracts the ball head 401 to connect the mobile phone clamp 1 with the support seat.

In order to further improve the stability between the magnetic accepter 403 and the ball head 401 that have attracted each other, a spherical groove 404 with the same diameter as the ball head 401 is formed on one side of the magnetic accepter 403 facing the ball head 401. When the magnetic accepter 403 is connected with the ball head 401, part of the ball head 401 is embedded in the spherical groove 404, so that the contact area between the ball head 401 and the magnetic accepter 403 can effectively increase, so as to improve the stability of the connection between the magnetic accepter 403 and the ball head 401; in this way, it is ensured that no free turn occurs to the mobile phone cannot after placing it on mobile phone clamp 1.

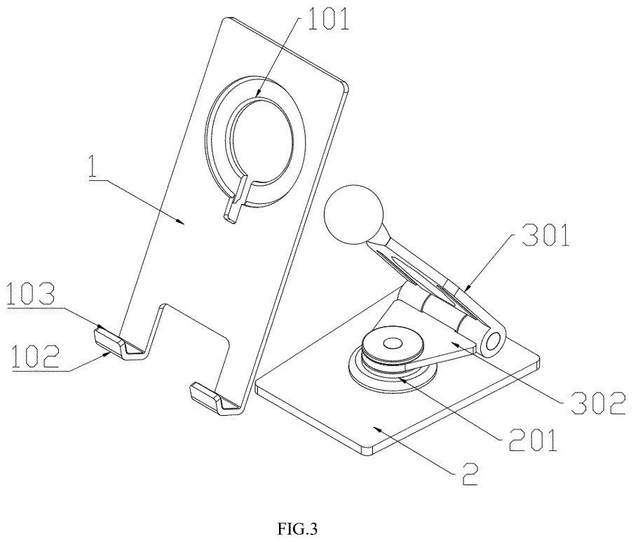

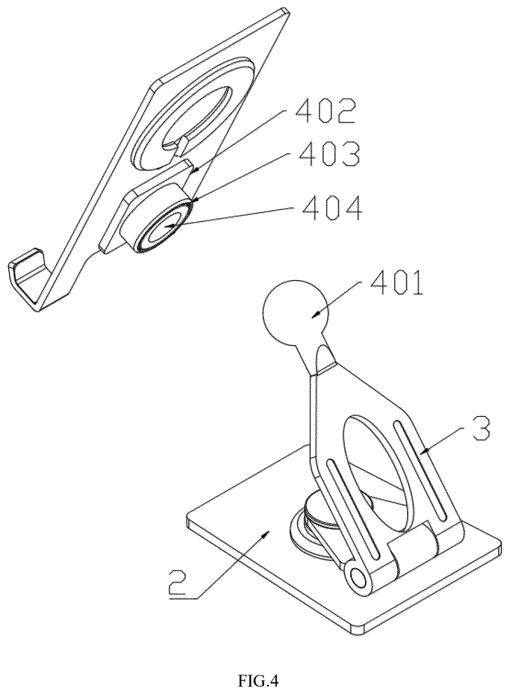

In an embodiment, as shown in FIGS. 1-4, the support seat includes a base 2 and a supporting arm 3, and the supporting arm 3 includes a movable connecting frame 301 fixed to the ball head 401 or the magnetic accepter 403 and a rotatable connecting frame 302 hinged with the movable connecting frame 301; and a turntable 201 that is rotatably connected with the rotatable connecting frame 302 is formed on the base 2.

By way of hinging the movable connecting frame 301 with the connecting frame 302, it is possible to adjust the height of the mobile phone clamp 1, so as to adapt to different usage requirements; therein, a damping piece is set at the hinge between the movable connecting frame 301 and the rotatable connecting frame 302, so as to ensure that the movable connecting frame 301 and the rotatable connecting frame 302 will not turn under the action of gravity after the mobile phone is placed on the mobile phone clamp 1; in addition, the rotatable connecting frame 302 and the base 2 are rotatably connected with each other through the turntable 201, so as to enable horizontal rotation of the mobile phone clamp 1 to adjust placement directions of the mobile phone clamp 1.

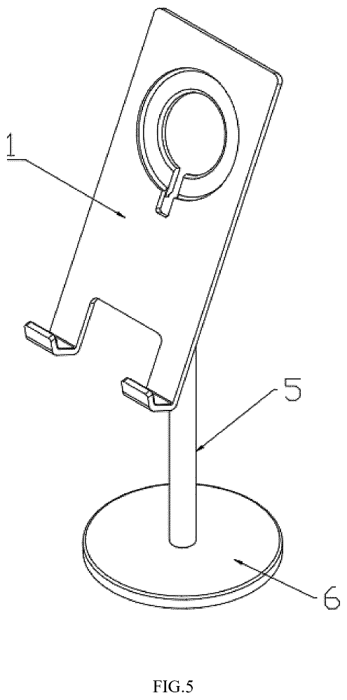

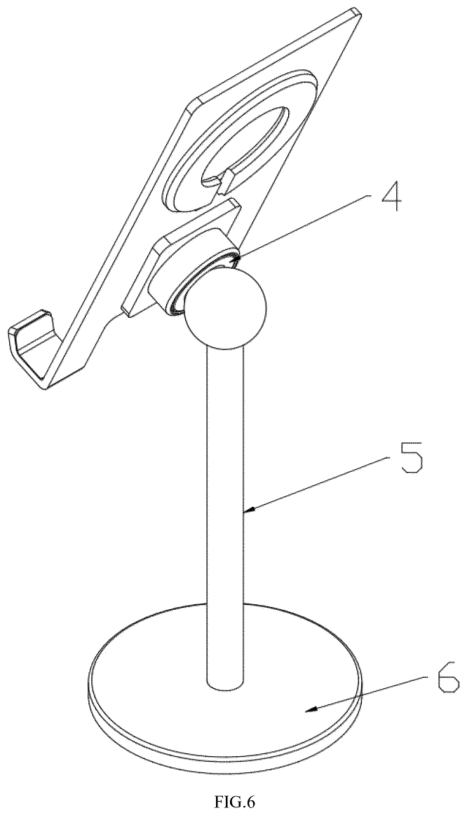

In another embodiment, as shown in FIGS. 5-6, the support seat includes a support 5 fixed to the ball head 401 or the magnetic accepter 403 and a mount 6 connected with the support 5; preferably, the support is in a shape of column, such as “>” or “<”. By way of arranging the support 5 and the mount 6, it is possible to enable an effective support to the mobile phone clamp 1.

For a person skilled in the art, it is clear that the present invention is not limited to the details of the above exemplary embodiments, and that the present invention can be implemented in other concrete forms without deviating from the spirit or essential features of the present invention. Therefore, the embodiments should be regarded as exemplary and non-limiting in any way, and the scope of the invention is defined by the claims and not by the above description; thus, any change falling within the meaning and scope of the equivalent elements of the claims will be incorporated in the present invention. Any mark in the claims shall not be deemed as a limitation to the claims where it is involved.

In addition, it should be understood that although the description has been presented in terms of embodiments, not each embodiment contains only one independent technical solution, and this mode of the description is for clarity only; accordingly, a person skilled in the art shall take the description as a whole, and technical solutions in each embodiment may also be appropriately combined with each other to form other embodiments that can be understood by a person skilled in the art.

What is claimed is:

1. An omnidirectionally adjustable mobile phone holder comprising:
a mobile phone clamp (1) having a supporting surface and a connecting surface, wherein a support piece used to restrict a mobile phone in position is arranged on the supporting surface;
a support seat used to contact a position for placement; and
a connecting piece (4) connected with the connecting surface of said mobile phone clamp (1) and said support seat, so as to enable multi-directional adjustment to said mobile phone clamp (1) with respect to said support seat.

2. The omnidirectionally adjustable mobile phone holder according to claim 1, wherein said support piece includes a bearing piece (102) formed at one end of said mobile phone clamp (1); a rubber cushion (103) is arranged at a position where said bearing piece (102) contacts a mobile phone.

3. The omnidirectionally adjustable mobile phone holder according to claim 1, wherein an embedment groove (101) is further set on said mobile phone clamp (1) and a camera protruding from a mobile phone is disposed inside said embedment groove (101).

4. The omnidirectionally adjustable mobile phone holder according to claim 1, wherein said connecting piece (4) includes a ball head (401) connected with said support seat and a magnetic accepter (403) fixed to the connecting surface of said mobile phone clamp (1), wherein said magnetic accepter (403) attracts said ball head (401) to connect said mobile phone clamp (1) with said support seat; or
said connecting piece (4) includes a magnetic accepter (403) connected with said support seat and a ball head (401) fixed to the connecting surface of said mobile phone clamp (1), wherein said magnetic accepter (403) attracts said ball head (401) to connect said mobile phone clamp (1) with said support seat.

5. The omnidirectionally adjustable mobile phone holder according to claim 4, wherein a spherical groove (404) with the same diameter as said ball head (401) is formed on one side of said magnetic accepter (403) facing said ball head (401).

6. The omnidirectionally adjustable mobile phone holder according to claim 4, wherein said support seat includes a base (2) and a supporting arm (3), and said supporting arm (3) includes a movable connecting frame (301) fixed to said ball head (401) or said magnetic accepter (403) and a rotatable connecting frame (302) hinged with said movable connecting frame (301);
a turntable (201) that is rotatably connected with said rotatable connecting frame (302) is formed on said base (2).

7. The omnidirectionally adjustable mobile phone holder according to claim 4, wherein said support seat includes a support (5) fixed to said ball head (401) or said magnetic accepter (403) and a mount (6) connected with said support (5).

8. The omnidirectionally adjustable mobile phone holder according to claim 7, wherein said support (5) is in a shape of column, such as “>” or “<”.
